(19) United States
(12) Patent Application Publication
(10) Pub. No.: US 2021/0121367 A1
(43) Pub. Date: Apr. 29, 2021

(54) BREAST-LIKE INFANT BOTTLE NIPPLE

(71) Applicants: Lindsey Dente, Granby, MA (US); Peter Joseph Colompos, Jonesville, VT (US)

(72) Inventors: Lindsey Dente, Granby, MA (US); Peter Joseph Colompos, Jonesville, VT (US)

(21) Appl. No.: 16/949,299

(22) Filed: Oct. 23, 2020

Related U.S. Application Data
(60) Provisional application No. 62/925,039, filed on Oct. 23, 2019.

(51) Int. Cl. A61J 11/00; A61J 9/00

(52) U.S. Cl. CPC A61J 11/005; A61J 9/00; A61J 11/002; A61J 11/008

(57) ABSTRACT

A baby bottle is provided for improving feeding tolerance and reducing nipple confusion. The bottle includes a cylindrical bottle; a nipple disk; a valve disk; and a retaining ring. The valve disk prevents liquid flow until the nipple is elongated to at least a predetermined length. The bottle has a threaded surface on an exterior of one end and the retaining ring has mating threads. The nipple disk is configured to mimic a natural breast, with an areola portion and a nipple portion. The valve disk has multiple openings. The valve disk is adjacent to the inside of the nipple disk. The baby bottle includes a piston slides within the bottle. The piston maintains vacuum within the bottle as liquid exits the nipple.

### CROSS-REFERENCE TO RELATED APPLICATION

This application claims the benefit of priority of U.S. provisional application No. 62/925,039, filed Oct. 23, 2019, the contents of which are herein incorporated by reference.

### BACKGROUND OF THE INVENTION

The present invention relates to neonatal bottles and, more particularly, to breast-like nipples therefor.

Neonates, especially those born prematurely, often experience feeding intolerance with standard bottle nipples. This can cause medical complications and prolonged inpatient stays in the Neonatal ICU.

Moreover, infants who become accustomed to bottle feeding in the first days or weeks of life often refuse to breastfeed because of the functional differences between the breast and the bottle. This refusal is commonly known as “nipple confusion”.

Standard bottle nipples are artificial in their functionality, texture, shape, and size. They require entirely different feeding behaviors on the part of the infant than a human breast does. In addition, standard infant bottle nipples often flow too quickly; flow rates vary widely between different brands of bottle nipples.

As can be seen, there is a need for a bottle that mimics the breast in shape, size, texture, and functionality.

The present invention provides a bottle and nipple therefor that mimics a breast, allowing an infant to control the flow rate of liquid and thereby improving feeding tolerance, particularly for premature or at-risk neonates. It also teaches proper latching and feeding behaviors that will ease the infant's transition to direct breastfeeding, preventing “nipple confusion” or breastfeeding refusal by bottle fed neonates.

### SUMMARY OF THE INVENTION

In one aspect of the present invention, a baby bottle is provided for improving feeding tolerance and reducing nipple confusion, comprising a substantially cylindrical bottle having a threaded surface on an exterior of one end; a nipple disk configured to mimic a natural breast, comprising an areola portion and a nipple portion with at least one opening; a valve disk having a plurality of openings adjacent to an interior surface of the nipple disk; and a retaining ring having a mating threaded surface to the threaded surface of the bottle; wherein the valve disk is operative to prevent liquid flow until the nipple is elongated to at least a predetermined length.

In another aspect of the present invention, a baby bottle for improving feeding tolerance and reducing nipple confusion, comprising a substantially cylindrical bottle; a nipple disk at a first end of the bottle, configured to mimic a natural breast comprising an areola portion and a nipple portion with at least one opening; and a piston positioned within the bottle and operative to maintain vacuum within the bottle as liquid exits the nipple; wherein the piston is slidably positioned within a second end of the bottle.

These and other features, aspects and advantages of the present invention will become better understood with reference to the following drawings, description, and claims.

### BRIEF DESCRIPTION OF THE DRAWINGS

FIG. 1 is a perspective view of a bottle according to an embodiment of the invention, with the cover removed;

FIG. 2 is a sectional view thereof, taken along line 2-2 in FIG. 1;

FIG. 3 is an exploded view thereof, including the cover;

FIG. 4 is a bottom perspective partially exploded view thereof;

FIG. 5 is a sectional view showing the bottle of FIG. 2 in use;

FIG. 6 is a sectional schematic view thereof, showing movement of the piston; and

FIG. 7 is a sectional schematic view thereof, showing manipulation of the piston.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a baby bottle with nipple configured to mimic a natural breast operatively attached thereto. The liquid flow may be controlled with a valve disk and/or a piston lock.

The inventive bottles may be used with a well newborn when direct breastfeeding alone provides inadequate breastmilk intake. Advantageously, the inventive bottles may prevent infants from becoming accustomed to the unnatural shape, texture, and flow rate of standard infant bottles. The bottles may also be used in the Neonatal ICU setting to promote breastfeeding success during periods when the infant's mother is not present to directly breastfeed.

In some embodiments, the inventive bottle diameter is substantially larger than currently commercially available bottles to accommodate a nipple having an anatomically correct shape.

In some embodiments, a plurality of interchangeable nipple types may be provided. The nipple type may be selected to match the infant's mother's anatomy and appropriate flow range for the child's needs, promoting familiarity with direct breastfeeding. For example, the nipple types may mimick a breast shape such as an everted shape, a flat shape, an inverted shape, and a large (or enlarged) nipple shape and density.

In some embodiments, the inventive bottle further comprises a valve disk to provide stability for the nipple and to prevent flow when the nipple is not extended properly. To allow liquid flow into the space between the nipple and valve disk, the infant may draw the nipple into the mouth as far as the soft palate, releasing the nipple from the valve disk. The valve disk may have a substantially circular shape and may conform to the internal surface of the areola portion of the nipple.

In some embodiments, a piston or piston lock may be provided to release the flow of milk into the reservoir in the tip of the nipple. The piston may also be used to delay flow until the infant is latched and suckling correctly at the nipple or to stop the flow of liquid to the infant at any time. The piston may comprise a substantially cylindrical body and a piston stem. The piston stem may be used to stop the movement of the piston and therefore the liquid flow by pressing the piston stem towards the sidewall of the bottle, i.e., perpendicular to the longitudinal axis of the bottle.

A retaining ring or lock ring may be provided to secure the nipple and valve disk to the bottle. The ring may be sufficiently tight to form a leakproof seal between the bottle, the nipple, and the valve disk. The retaining ring may be screwed on and may be removed.

In some embodiments, a removable cover may be provided to protect the nipple disk from contamination.

The materials of manufacture are not particularly limited. The nipple may be made, for example, of food-grade silicone. The bottle may be manufactured of any suitable food-grade plastic.

The nipple may be manufactured using any suitable method. For example, the nipple may be molded using three-dimensional (3-D) printed plastic molds. The molding process may be done at about room temperature. The mold design may incorporate an insert to allow easy modification to the inside of the nipple. For example, the insert may be used to create an anatomically correct density. Surface texture features of the nipple, such as “Montgomery Glands” (i.e., protrusions on the breast that look like skin goosebumps), may be manually added to the mold surface, for example, with a Dremel® power operated hand tool. The material thickness may be adjusted in the area supporting the nipple to get proper nipple extension, for example, by adjusting the mold shut height.

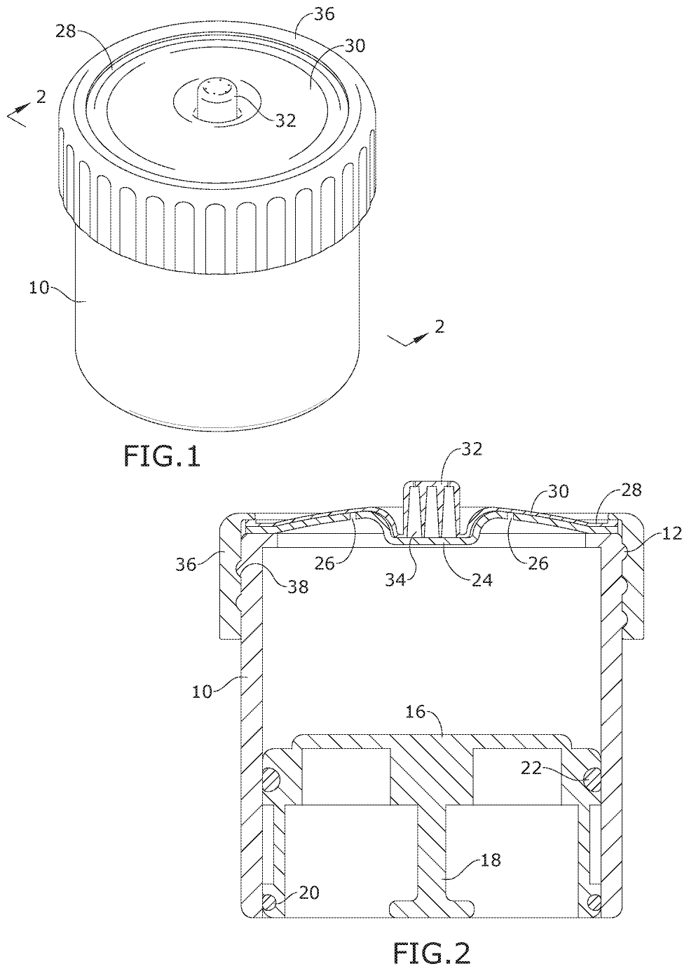

Referring to FIGS. 1-7, FIGS. 1 and 2 show a bottle 10 with a nipple disk 28, having an areola portion 30 and a nipple 32, and a lock ring 36 attached and without a cover 40. As shown in FIG. 2, The nipple 32 is provided with nipple openings 34. A valve disk 24, conforming to and adjacent to the inner surface of the nipple disk 28, has valve disk openings 26 aligned with the center of the areola portion 30. Lock ring receiving threads 12 on the bottle 10 are operative to interlock with lock ring threads 38 on the interior of the lock ring 36, holding both the nipple disk 28 and the valve disk 24 in place. Within the bottle 10, a piston 16 with a piston stem 18 is sealed with a lower O-ring 20 and an upper O-ring 22.

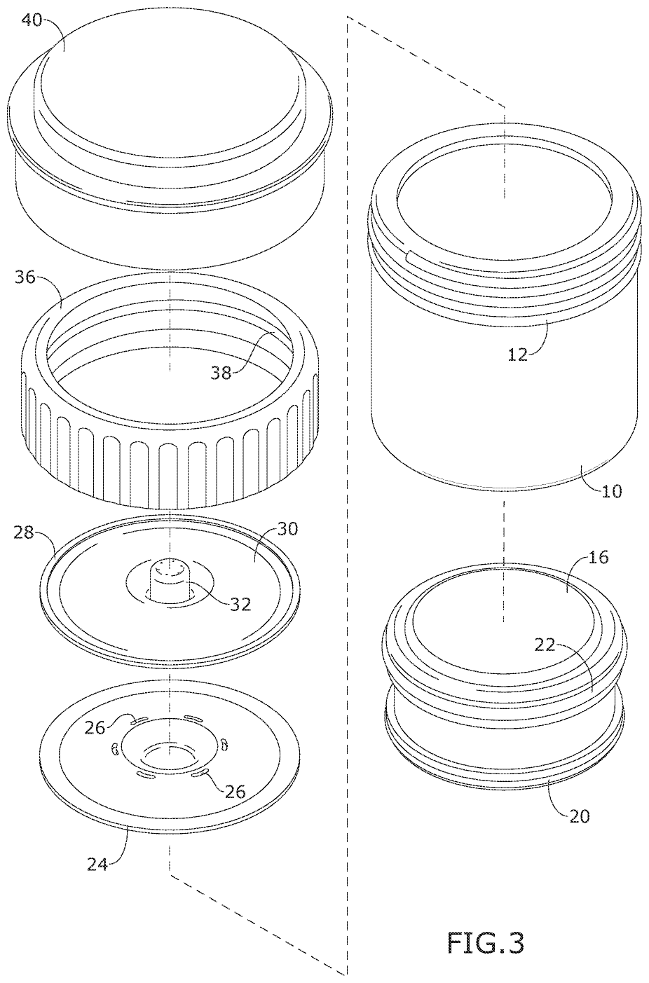

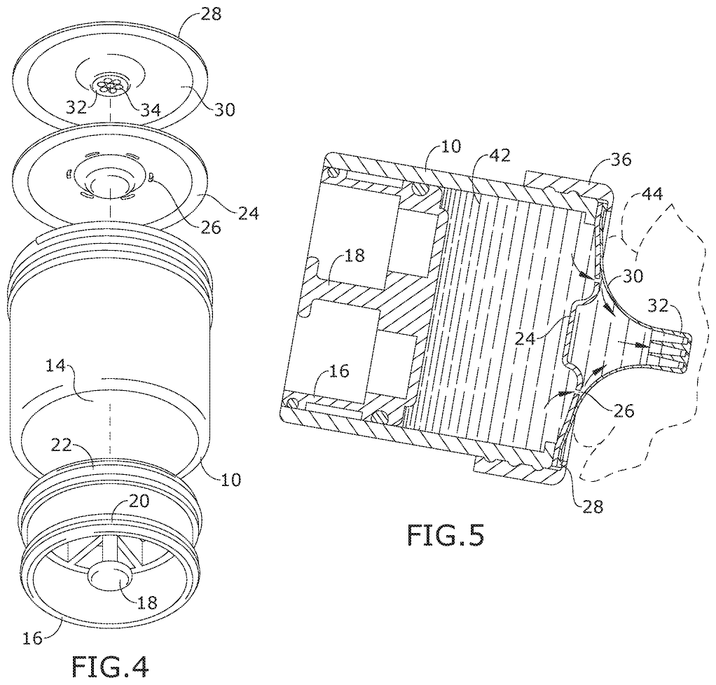

The exploded views of FIGS. 3 and 4 illustrate the position of the piston 16 in the bottom piston opening 14 of the bottle 10, while the valve disk 24 and nipple disk 28 are secured at the distal end of the bottle 10 with the lock ring 36 and may be covered with the cover 40.

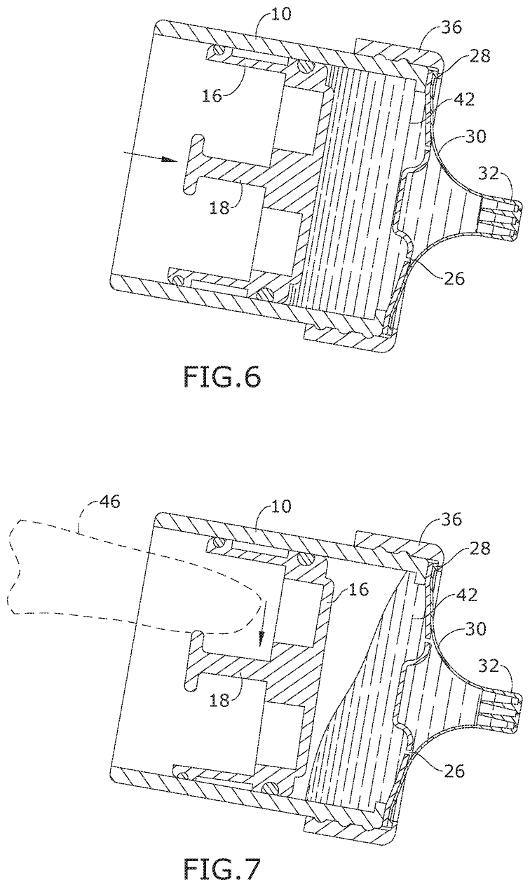

FIG. 5 illustrates extension of the nipple 32 when the infant's mouth 44 is fully latched onto the nipple 32 and areola portion 30, allowing flow of fluid 42 through the openings 26 in the valve disk 24 and subsequently through the openings 34 in the nipple disk 28. FIG. 6 illustrates movement of the piston 16 to maintain a vacuum as the infant feeds. FIG. 7 illustrates a user's finger 46 pressing the piston stem 18, perpendicular to the direction of movement shown in FIG. 6, to stop the movement of the piston 16.

It should be understood, of course, that the foregoing relates to exemplary embodiments of the invention and that modifications may be made without departing from the spirit and scope of the invention as set forth in the following claims.

What is claimed is:

1. A baby bottle for improving feeding tolerance and reducing nipple confusion, comprising:
a. a substantially cylindrical bottle having a threaded surface on an exterior of one end;
b. a nipple disk configured to mimic a natural breast, comprising an areola portion and a nipple portion with at least one opening;
c. a valve disk having a plurality of openings adjacent to an interior surface of the nipple disk; and
d. a retaining ring having a mating threaded surface to the threaded surface of the bottle;
wherein the valve disk is operative to prevent liquid flow until the nipple is elongated to at least a predetermined length.

2. The baby bottle of claim 1, further comprising a piston comprising a piston stem, wherein said piston is operative to maintain vacuum within the bottle as liquid exits the nipple.

3. The baby bottle of claim 1, further comprising a removable cover, wherein said removable cover is operative to protect the nipple disk from contamination.

4. The baby bottle of claim 1, wherein the nipple disk has a shape mimicking a breast shape selected from a group consisting of: everted, flat, inverted, and enlarged.

5. The baby bottle of claim 1, wherein the valve disk substantially conforms to the interior surface of the nipple disk.

6. A baby bottle for improving feeding tolerance and reducing nipple confusion, comprising:
a. a substantially cylindrical bottle;
b. a nipple disk at a first end of the bottle, configured to mimic a natural breast comprising an areola portion and a nipple portion with at least one opening; and
c. a piston positioned within the bottle and operative to maintain vacuum within the bottle as liquid exits the nipple;
wherein the piston is slidably positioned within a second end of the bottle.

7. The baby bottle of claim 6, wherein the piston comprises a substantially cylindrical body and a piston stem, wherein said piston stem is operative to stop movement of the piston when pressed perpendicular to a longitudinal axis of the bottle.

8. The baby bottle of claim 6, further comprising a valve disk having a plurality of openings adjacent to an internal surface of the nipple disk, wherein said valve disk is operative to prevent liquid flow until the nipple is elongated to at least a predetermined length.

9. The baby bottle of claim 8, further comprising a lock ring removably attached to the bottle, wherein the lock ring is operative to attach the nipple disk and the valve disk to the bottle to form a leakproof seal.

10. The baby bottle of claim 6, further comprising a removable cover, wherein the removable cover is operative to protect the nipple disk from contamination.
